(19) United States
(12) Patent Application Publication
(10) Pub. No.: US 2026/0111905 A1
(43) Pub. Date: Apr. 23, 2026

(54) INCIDENT-RELATED TREND AND STATISTICAL EXCEPTION RECOGNITION AND AI-BASED AUTOMATED INCIDENT CLASSIFICATION AND RESOLUTION

(71) Applicant: JPMorgan Chase Bank, N.A., New York, NY (US)

(72) Inventors: Miguel Andina Silva, Buenos Aires (AR); Alejandro Lago, Buenos Aires (AR)

(73) Assignee: JPMorgan Chase Bank, N.A., New York, NY (US)

(21) Appl. No.: 18/924,196

(22) Filed: Oct. 23, 2024

(51) Int. Cl. G06Q 30/015; G06F 18/241

(52) U.S. Cl. CPC G06Q 30/015; G06F 18/241; G06F 40/20; G06Q 10/063112; G06Q 10/0639; H04L 41/5074

(57) ABSTRACT

Aspects of the subject disclosure may include, for example, obtaining a description of an incident relating to an entity, wherein the description is provided from a user device associated with a user, and wherein the entity comprises a product or a service that is offered by an organization to a plurality of users that includes the user, generating, using an AI model, a recommended classification for the incident based on the obtaining, wherein the generating involves converting the description into a vector and performing semantic searching for the vector in one or more databases of vectors, and based on the recommended classification, causing an automated pre-programmed script to be deployed the user device, wherein deployment of the automated pre-programmed script triggers the user device to execute the automated pre-programmed script to resolve the incident. Other embodiments are disclosed.

### FIELD OF THE DISCLOSURE

The subject disclosure generally relates to incident-related trend and statistical exception recognition and artificial intelligence (AI)-based automated incident classification and resolution.

### BACKGROUND

Many organizations offer software products (e.g., enterprise software applications, e-mail systems, mobile device management applications, etc.) to users, such as employees or clients, and staff a help desk with a support ticket system or scheme to service any incidents (i.e., problems or issues) that the users may experience when using these products. Oftentimes, general issues that impact many users go unidentified for days or weeks, which delays root cause analyses and the identification of corresponding resolutions and workarounds. Such delays can lead to prolonged disruptions and decreased user satisfaction. Even if a particular issue with a product is identified, the problem is usually not well linked to relevant solutions and identifiable using keyword searches. This makes it difficult to automatically provide a resolution to affected users at support ticket creation time. The manual process of reviewing and categorizing tickets is also time consuming and prone to errors. Furthermore, manually reviewing all of the data to identify significant trends and anomalies relating to support tickets on a daily basis can be an insurmountable task, even if many human data analysts are available for this purpose. The large volume of data and the complexity of identifying meaningful patterns therefore make reliance solely on human reviewers insufficient. This limitation hinders the help desk's ability to detect and respond to issues promptly, which results in operational inefficiencies. Additionally, existing help desk operations are prone to inefficient resource utilization. The supporting analytical tools and systems, such as databases, search algorithms, etc., that analysts manually access to help address incidents can require significant resources to run. This inefficiency is compounded by the lack of a scalable architecture, as the typical help desk system cannot dynamically adjust to fluctuating volumes of incident reports. During peak times, the system may become overwhelmed, whereas during off-peak times, systems generally remain fully operational, which results in wasted resources. Help desk analysts are also prone to treating all incoming data equally without necessarily prioritizing high-impact incidents. This can result in further undue and inefficient consumption of computing resources and power resources.

### SUMMARY OF THE DISCLOSURE

One or more aspects of the subject disclosure may include a device, comprising a processing system including a processor, and a memory that stores executable instructions that, when executed by the processing system, facilitate performance of operations. The operations may include obtaining a description of an incident relating to an entity, wherein the description is provided from a user device associated with a user, and wherein the entity comprises a product or a service that is offered by an organization to a plurality of users that includes the user. Further, the operations may include generating, using an AI model, a recommended classification for the incident based on the obtaining, wherein the generating involves converting the description into a vector and performing semantic searching for the vector in one or more databases of vectors. Further, the operations may include based on the recommended classification, causing an automated pre-programmed script to be deployed the user device, wherein deployment of the automated pre-programmed script triggers the user device to execute the automated pre-programmed script to resolve the incident.

One or more aspects of the subject disclosure may include a non-transitory machine-readable medium, comprising executable instructions that, when executed by a processing system including a processor, facilitate performance of operations. The operations may include training an AI model using results of statistical exception analysis of incident data relating to a plurality of entities, wherein the AI model is trained to generate recommended classifications of incidents associated with one or more of the plurality of entities, wherein the training of the AI model involves fine tuning of a transformer-based pre-trained model that understands natural language, wherein the fine tuning is based on text in the incident data, and wherein the plurality of entities comprise products or services that are offered by an organization to a plurality of users. Further, the operations may include causing one or more instances of the AI model to be deployed into one or more service environments to facilitate automatic classification or resolution of reported incidents.

One or more aspects of the subject disclosure may include a method. The method may include receiving, by a processing system including a processor, a description of an incident relating to an entity, wherein the description is provided from a user device associated with a user, and wherein the entity comprises a product or a service that is offered by an organization to a plurality of users that includes the user. Further, the method may include responsive to the receiving, predicting, by the processing system and using an artificial intelligence (AI) model, a classification for the incident based on the description, wherein the predicting comprises converting the description into a vector and performing semantic searching for the vector in one or more databases of vectors. Further, the method may include based on the classification, causing, by the processing system, an automated pre-programmed script to be deployed the user device, wherein deployment of the automated pre-programmed script triggers the user device to execute the automated pre-programmed script to resolve the incident.

### BRIEF DESCRIPTION OF THE DRAWINGS

Reference will now be made to the accompanying drawings, which are not necessarily drawn to scale, and wherein:

FIG. 1 illustrates an example incident classification and resolution framework in accordance with various aspects described herein.

FIG. 2A is a flow diagram illustrating an example process for incident-related trend and statistical exception detection and AI model training in accordance with various aspects described herein.

FIG. 2B illustrates an example pivot table for performing incident-related trend and statistical exception calculations in accordance with various aspects described herein.

FIG. 2C illustrates an example table of data that is created from results of incident-related trend and statistical exception calculations in accordance with various aspects described herein.

FIG. 2D illustrates an example chart of data that is created from results of incident-related trend and statistical exception calculations in accordance with various aspects described herein.

FIG. 2E illustrates an example word cloud that is created from results of incident-related trend and statistical exception calculations in accordance with various aspects described herein.

FIGS. 2F and 2G illustrate example portions of a user interface (UI) for presenting results of incident-related trend and statistical exception calculations in accordance with various aspects described herein.

FIG. 2H illustrates an example user communication that includes results of incident-related trend and statistical exception calculations in accordance with various aspects described herein.

FIG. 3A is a flow diagram illustrating an example process for real-time (or near real-time) automated AI-based incident classification and resolution.

FIG. 3B is a diagram of an example AI architecture, which may be used to facilitate training or pre-training of one or more large language models (LLMs), in accordance with various aspects described herein.

FIG. 3C is a diagram of an example transformer model, a portion or an entirety of which may serve as a functional building block of one or more LLMs, in accordance with various aspects described herein.

FIG. 3D is a diagram of an example Bidirectional Encoder Representations from Transformers (BERT)-based model in accordance with various aspects described herein.

FIG. 4 is a block diagram of an example, non-limiting embodiment of a computing environment in accordance with various aspects described herein.

### DETAILED DESCRIPTION

The subject disclosure generally relates to an incident data analysis and classification and resolution system that is capable of facilitating incident-related trend and statistical exception detection as well as automated AI-based classification and resolution of incidents in real-time, such as upon receipt of an incident report (e.g., at support ticket creation). Incidents may relate to products/services that are offered by an organization to users, such as employees, clients, etc. In exemplary embodiments, the incident data analysis and classification and resolution system may perform statistical analyses of incident data to identify recurring issues, derive baseline data for training/re-training an AI model based on results of the statistical analyses, and utilize the AI model to generate recommendations for classifying and/or resolving incidents. The recommendations may include suggestions to use identified scripts (i.e., pre-programmed instructions) that can be deployed to user devices to automatically resolve specific issues. The recommendations may additionally, or alternatively, include suggestions to associate reported incidents with known recurrent issues. The recommendations may additionally, or alternatively, include suggestions to route reported incidents to technical working groups (e.g., particular teams or departments) for specialized handling.

Embodiments of the incident data analysis and classification and resolution system advantageously enable an organization to quickly respond to known problems and manage and resolve incidents more efficiently, thereby enhancing user satisfaction and operational performance. Exemplary embodiments of the incident data analysis and classification and resolution system also advantageously improve resource utilization and enhance operational efficiency by addressing the above-discussed issues that tend to be inherent in typical help desk setups. By automating the processing of incident data using AI-driven analytics, the incident data analysis and classification and resolution system reduces or eliminates the need for resource-intensive manual analysis, which reduces the computer and power resource demands that are typically associated with the use of manually-operated support tools. Having a scalable architecture, the system can dynamically adjust to varying volumes of incident reports—i.e., by scaling down its computational resource usage, such as by reducing active processing units or reallocating resources to other tasks—which reduces computing and power resource usage especially at off-peak times when few incidents are being reported. Additionally, by prioritizing high-impact incidents, rather than treating all data equally, the incident data analysis and classification and resolution system also provides for more efficient data processing, which further reduces computing and power resource usage.

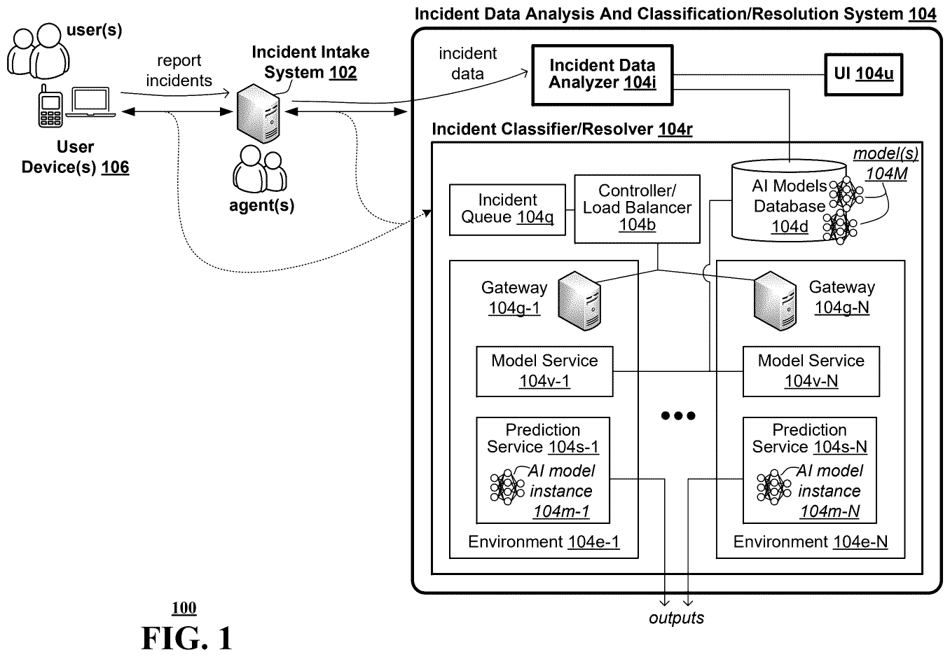

Referring to FIG. 1, an incident classification/resolution framework 100 of an organization may involve an incident intake system 102, an incident data analysis and classification and resolution system 104, and user device(s) 106.

The user device(s) 106 may include one or more computing devices that are capable of inputting/outputting user inputs and communicating information with other devices/systems. A user device 106 may include a desktop computer, a laptop computer, a tablet computer, a mobile phone, a wearable device (e.g., a smart wristwatch, a pair of smart eyeglasses, media-related gear (e.g., augmented reality (AR), virtual reality (VR), or mixed reality (MR) glasses and/or headset/headphones)), any other similar type of device, any other different type of device, or a combination of some or all of these devices.

The incident intake system 102 may exemplify at least a portion of a help desk department in an organization, and may be implemented in one or more computing devices. These computing device(s) may be operated by one or more (e.g., human) service representatives or agents to facilitate the creation and management of support tickets based on user-reported incidents. Incidents may relate to products/services that the organization may offer to users (e.g., employees, clients, etc.). These products/services may include software applications or features, such as spreadsheet applications, e-mail applications, communication applications, database management applications, employee rewards, access control to one or more systems using user credentials, etc. The users may, by way of the user device(s) 106, report incidents to the incident intake system 102 for resolution.

The incident data analysis and classification and resolution system 104 may include an incident data analyzer 104i, a UI 104u, and an incident classifier/resolver 104r. The incident data analyzer 104i may be capable of analyzing incident data, which may be obtained from the incident intake system 102. The analysis may involve identifying patterns, trends, and/or statistical exceptions in the incident data. The incident data analyzer 104i may also be capable of using analysis results to train AI model(s) 104M.

The UI 104u may be capable of presenting incident data analysis results and providing interactive controls for user review of the analysis results. For example, the UI 104u may present various information, such as trend alerts relating to identified statistical exceptions in reported incidents and/or other relevant information, where users may select (e.g., via point and click or touch inputs) to view various layers of information, such as raw data extracts and/or generated tables or charts relating to identified trends.

The incident classifier/resolver 104r may be capable of facilitating automated incident classification and resolution (e.g., in real-time or near real-time) using the trained AI model(s) 104M. The incident classifier/resolver 104r may include an incident queue 104q, a controller/load balancer 104b, and an AI models database 104d for storing the AI model(s) 104M. The incident classifier/resolver 104r may also include environments 104e-1 through 104e-N, which may respectively include gateways 104g-1 through 104g-N, model services 104v-1 through 104v-N, prediction services 104s-1 through 104s-N, and AI model instances 104m-1 through 104m-N. Note that N≥1, and the respective components may hereinafter be referred to collectively as environments 104e, gateways 104g, model services 104v, prediction services 104s, and AI model instances 104m, may hereafter be referred to individually as environment 104e, gateway 104g, model service 104v, prediction service 104s, and AI model instance 104m or by specific designation, such as environment 104e-1, 104e-2, etc., gateway 104g-1, 104g-2, etc., model service 104v-1, 104v-2, etc., prediction service 104s-1, 104s-2, etc., and AI model instance 104m-1, 104m-2, etc.

The incident queue 104q may be configured to store and manage the flow of reported incidents for classification and resolution. The controller/load balancer 104b may be configured to read reported incidents from the incident queue 104q and distribute the workload of handling the reported incidents across the various environments 104e by communicating with the gateways 104g.

Each environment 104e may be designed to provide isolated and scalable resources for processing incident reports. For example, an environment 104e may utilize containerization or virtualization technologies to ensure that the AI model instances 104m operate in a consistent and efficient manner. This isolation helps to prevent interference between different AI model instances 104m and ensures that each such model instance has access to the needed computational resources.

The model services 104v may be capable of managing corresponding instances of the AI model(s) 104M—i.e., AI model instances 104m-1, 104m-2, etc. For example, the model services 104v may configure and/or facilitate updating of the corresponding AI model instances 104m. The prediction services 104s may be configured to utilize the AI model instances 104m to generate incident classification and resolution recommendations.

In one or more embodiments, the environments 104e may store data relating to reported incidents and associated classifications/resolutions. This data may be stored in object-based storage systems, where the data is organized into distinct units (e.g., objects). Each object may include the incident report, any metadata describing the report, and any classification/resolution recommendation that may be generated by an AI model instance 104m for the incident. These objects may be stored in containers or buckets, which provide a structured way to organize and manage the data. For example, an environment 104e may create a bucket to store all incident reports relating to a specific software application. Within this bucket, each incident report may be stored as an object, along with any relevant metadata and classification and resolution information. This organization allows for efficient retrieval and analysis of incident data, which enables the incident data analysis and classification and resolution system 104 to continuously improve its performance and accuracy.

As described in more detail below, the incident data analysis and classification and resolution system 104, and more particularly the incident classifier/resolver 104r, may be configured to intake reports of incidents from the user device(s) 106 and/or from the incident intake system 102, and attempt to automatically classify/resolve the incidents.

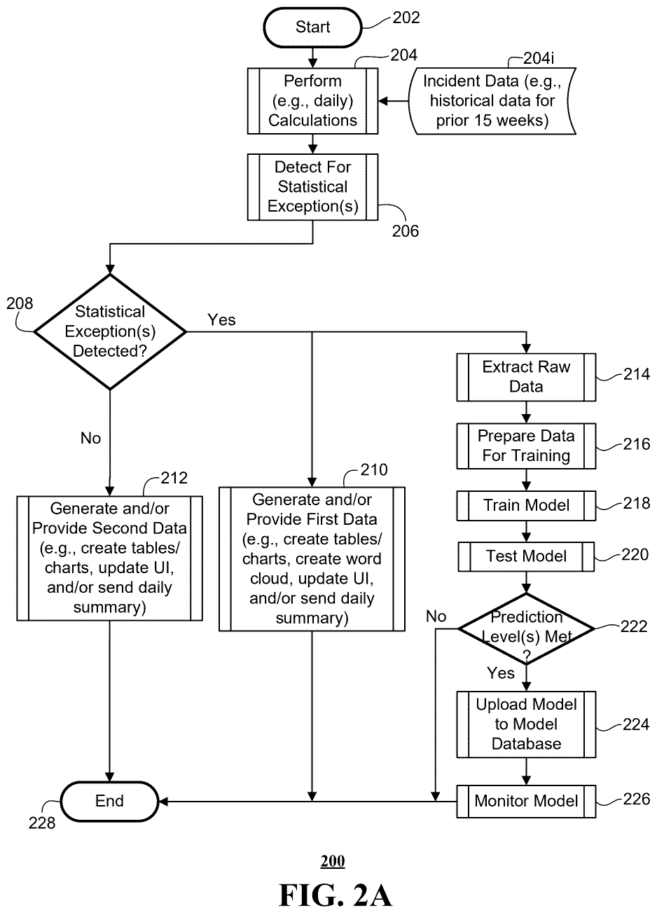

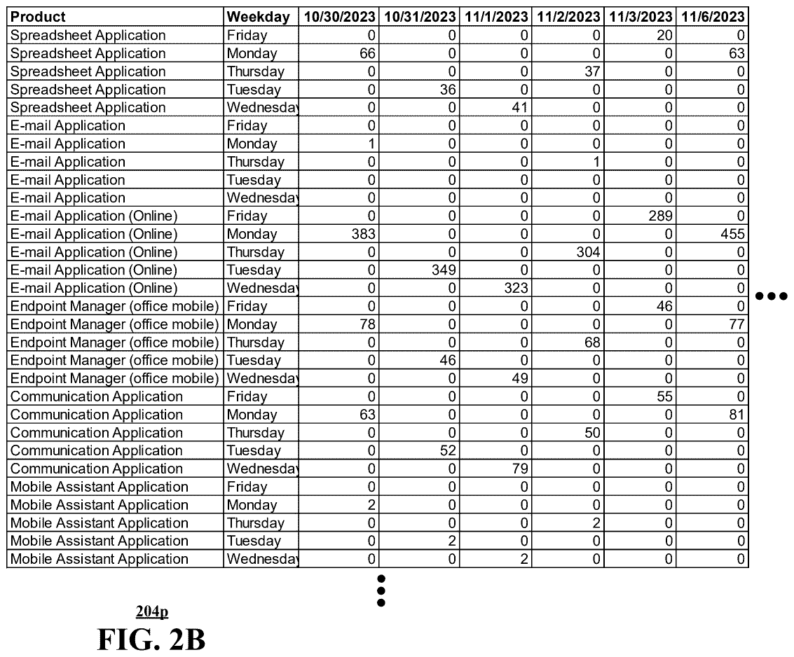

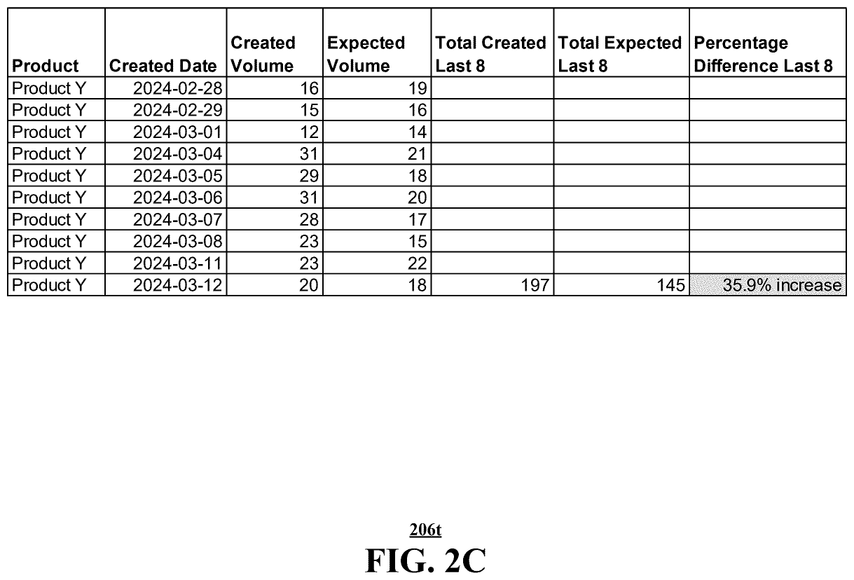

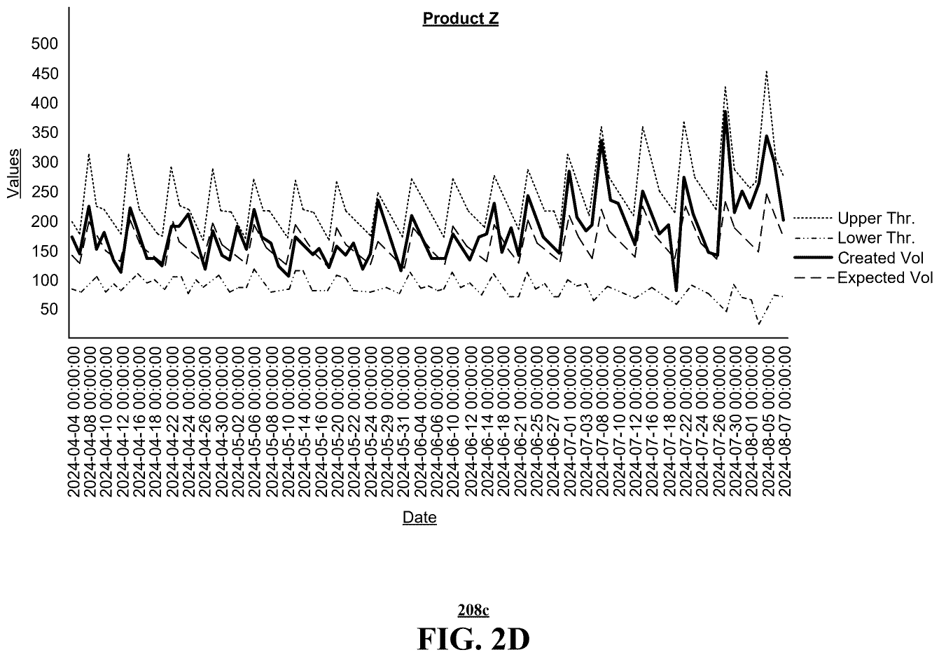

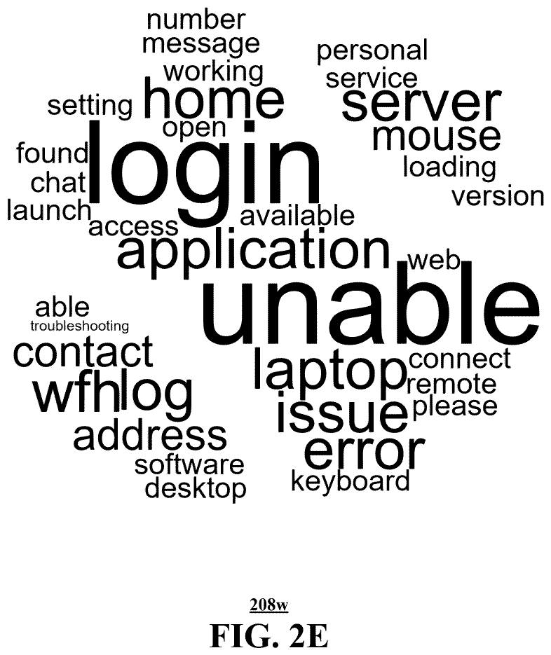

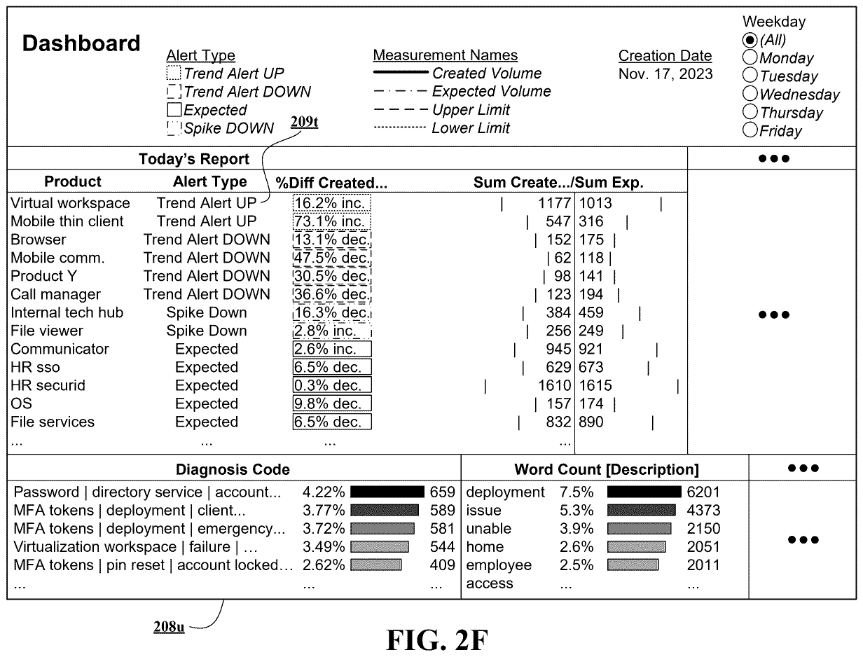

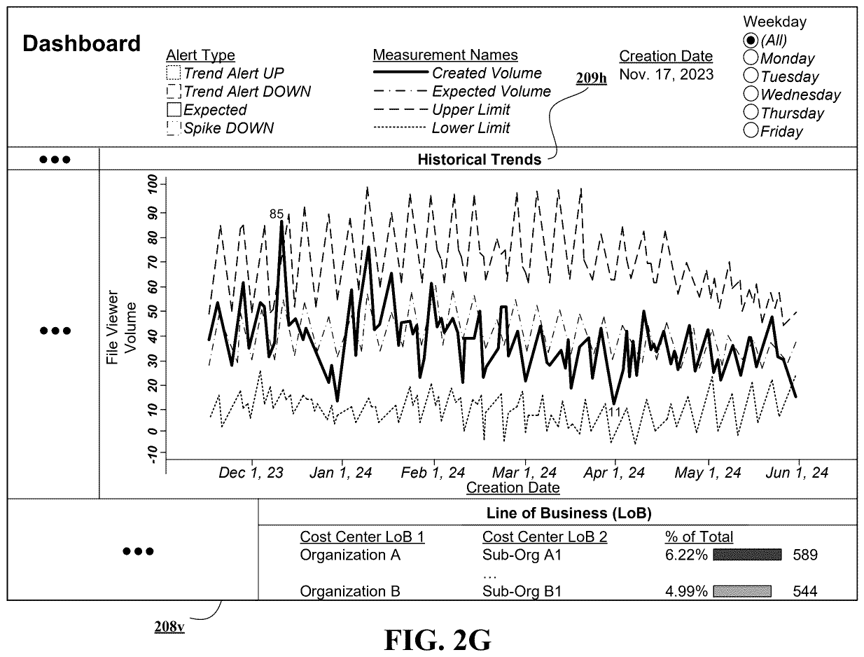

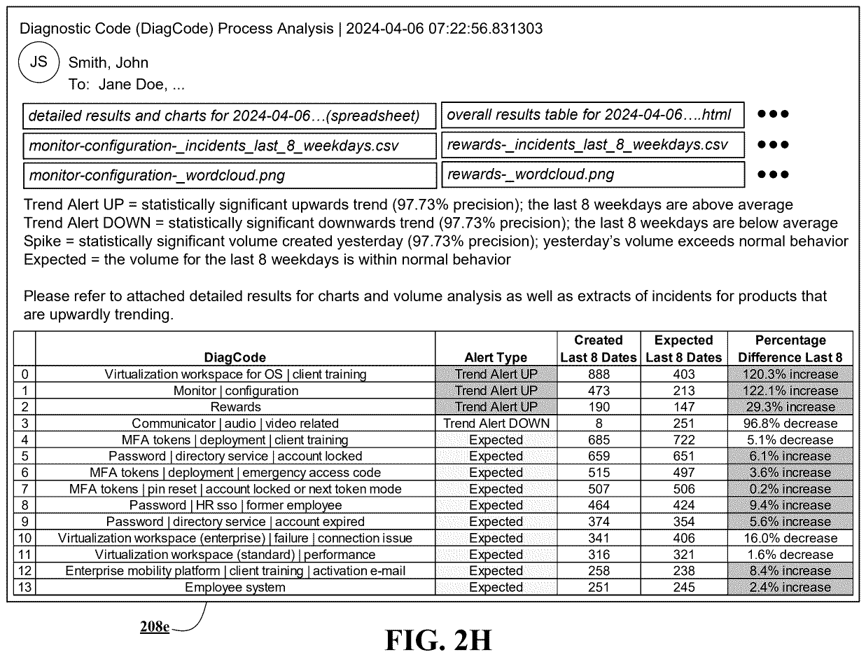

Referring to FIG. 2A, a process 200 is illustrated. The process 200 may be performed by the incident data analyzer 104i of the incident data analysis and classification and resolution system 104, and may begin at 202.

At 204, the incident data analyzer 104i may perform calculations. The incident data analyzer 104i may perform calculations based on incident data 204i. The incident data 204i may be stored in a spreadsheet or other file format, and may identify entities and each incident (e.g., user-reported incident) relating to each of the entities on each of one or more dates (e.g., multiple dates). The entities may include the names of software applications or features that are provided to users. For example, the entities may include the name of a spreadsheet application, the name of an e-mail application, the name of a communication (or messaging) application, the name of a system service (e.g., directory service), the name of a feature or benefit (e.g., employee rewards, access control to one or more systems using user credentials, etc.), and so on. Incidents relating to some or all of the entities may be reported by various users on various dates and recorded in the incident data 204i. As an example, the incident data 204i may include, for each date (e.g., Oct. 30, 2023, Oct. 31, 2023, etc.), a row or line item corresponding to each entity for which an incident was reported. Continuing the example, if on a particular date (e.g., Nov. 3, 2023), twenty individual incidents for the spreadsheet application and fifty-five individual incidents for the communication application were reported, the incident data 204i may include, seventy-five individual entries for the particular date, twenty of which identify the spreadsheet application and fifty-five of which identify the communication application. The incident data 204i may also include, for one or more entities, corresponding diagnostic codes or references (‘diagCodes’). As an example, the incident data 204i may include a diagnostic code for a specific issue encountered with a directory service, such as “Directory Service |Forgot Password,” which can identify a password-related category relating to the directory service.

In various embodiments, the incident data analyzer 104i may perform the calculations using an amount of incident data 204i that is deemed sufficient to provide reliable statistics. For example, the incident data analyzer 104i may, based on a current date, perform the calculations using data in the incident data 204i that spans one or more (e.g., each) of the prior 120 dates and 105 consecutive dates back from each such prior date, which provides calculations for 15 occurrences of each day of the week. In one or more embodiments, the incident data analyzer 104i may perform the calculations on a periodic basis, such as hourly, daily, weekly, etc.

In various embodiments, the incident data analyzer 104i may create a pivot table to facilitate the calculations. The pivot table may facilitate tallying of the incidents associated with the entities on a per weekday basis. Referring to FIG. 2B, an example pivot table 204p is illustrated. The incident data analyzer 104i may count the total number of incidents in the incident data 204i for each entity for each weekday (e.g., Monday through Friday), and may populate the pivot table 204p accordingly. For instance, in the aforementioned example in which twenty individual incidents for the spreadsheet application and fifty-five individual incidents for the communication application were reported on Friday, Nov. 3, 2023, the incident data analyzer 104i may count up the total number of incidents that were reported for the spreadsheet application and populate the appropriate entry in the pivot table 204p with the counted value (i.e., ‘20’ in the cell corresponding to the spreadsheet application, Friday, and Nov. 3, 2023). Similarly, the incident data analyzer 104i may count up the total number of incidents that were reported for the communication application and populate the appropriate entry in the pivot table 204p with the counted value (i.e., ‘55’ in the cell corresponding to the communication application, Friday, and Nov. 3, 2023).

In certain embodiments, the incident data analyzer 104i may perform statistical calculations on the incident data 204i using the pivot table. The incident data analyzer 104i may calculate various statistics and add corresponding columns and entries to the pivot table. The incident data analyzer 104i may calculate or determine the sum of incidents for each weekday (e.g., for each Monday in the dataset, for each Tuesday in the dataset, etc.) for each entity. The incident data analyzer 104i may also calculate or determine an average number of incidents for each weekday for each entity (e.g., the average number of incidents for all Mondays in the dataset by summing all of the incidents for all Mondays in the dataset and dividing by the total number of Mondays in the dataset; the average number of incidents for all Tuesdays in the dataset by summing all of the incidents for all Tuesdays in the dataset and dividing by the total number of Tuesdays in the dataset; etc.). For example, if the number of incidents reported on two Mondays for a spreadsheet application are 10 and 15, respectively, the incident data analyzer 104i may calculate the average number of incidents for Mondays as (10+15)/2=12.5.

The incident data analyzer 104i may further calculate or determine a standard deviation value for each entity for each weekday (e.g., for Mondays, for Tuesdays, etc.), set upper and/or lower thresholds based on the standard deviation, and eliminate outliers in the incident data 204i based on the threshold(s). This may involve calculating the variance by subtracting the average from each data point, squaring the result, and then averaging these squared differences. For example, in the aforementioned example where the number of incidents reported on two Mondays for a spreadsheet application are 10 and 15, respectively, the incident data analyzer 104i may calculate the variance as (10−12.5)²=6.25 and (15−12.5)²=6.25, resulting in a sum of 12.5. Continuing the example, the incident data analyzer 104i may then calculate the standard deviation by taking the square root of the variance—i.e., √12.5≈3.54. Further continuing the example, the incident data analyzer 104i may calculate an upper threshold based on a multiple (e.g., 3) of the standard deviation—i.e., 12.5+(3*3.54)≈23.12 and/or may calculate a lower threshold based on a multiple (e.g., 3) of the standard deviation—i.e., 12.5−(3*3.54)≈1.88. Still further continuing the example, incident data analyzer 104i may apply the threshold(s) to the incident data 204i to eliminate outliers—e.g., eliminate, for the spreadsheet application, the data for any Monday on which more than the upper threshold number of incidents were reported and/or the data for any Monday on which fewer than the lower threshold incidents were reported.

In one or more embodiments, the incident data analyzer 104i may utilize predefined upper and/or lower thresholds for outlier elimination. A predefined upper threshold may, for instance, be 100, which may be selected based on an analysis of historical data. A predefined lower threshold may, for instance be 10, which may similarly be selected based on an analysis of historical data.

The incident data analyzer 104i may, after eliminating outlier data for a given entity for a given weekday (e.g., for Mondays, for Tuesdays, etc.), re-calculate the average based on the remaining total sum of incidents for that weekday (e.g., for Mondays, for Tuesdays, etc.) and the total count of the remaining instances of that weekday (e.g., the total number of Mondays remaining after outlier elimination, the total number of Tuesdays remaining after outlier elimination, etc.). The re-calculated average then represents the average number of incidents for each weekday (e.g., for Mondays, for Tuesdays, etc.), which is referred to herein as the expected volume for the weekday.

Referring again to FIG. 2A, at 206, the incident data analyzer 104i may detect for statistical exception(s) in the incident data 204i based on result(s) of the calculations performed at step 204. In various embodiments, the incident data analyzer 104i may detect for statistical exceptions by identifying, for each entity, the data points in the incident data 204i that span a predefined period. For example, the incident data analyzer 104i may identify the last eight data points for each entity (i.e., over the last eight dates, such as the total number of incidents one weekday ago for the spreadsheet application, the total number of incidents one weekday ago for the e-mail application, etc., the total number of incidents eight weekdays ago for the spreadsheet application, the total number of incidents eight weekdays ago for the e-mail application, etc.). The eight data points provide a snapshot of recent incidents that were reported for each entity.

The incident data analyzer 104i may compare each of the identified data points for each entity with the expected volume for the corresponding weekday (e.g., the expected volumes that were calculated as described above with respect to step 204). For example, if, of the last eight dates, one weekday ago was a Monday, then the incident data analyzer 104i may, for each entity, compare the number of incidents reported on that one weekday ago with the expected volume for Mondays that was calculated for the date of one weekday ago (say, e.g., 12.5 incidents for the spreadsheet application). Continuing the example, if, of the last eight dates, two weekdays ago was a Friday, then the incident data analyzer 104i may compare the number of incidents reported on that two weekdays ago with the expected volume for Fridays that was calculated for the date of two weekdays ago (e.g., say, 15 incidents for the spreadsheet application). Further continuing the example, the incident data analyzer 104i may perform such a comparison for each of the last eight dates.

The incident data analyzer 104i may detect for statistical exception(s) in the last eight data points for each entity based on predefined statistical rules. For instance, the incident data analyzer 104i may consider one or more of the following scenarios as a statistical exception: (i) if the last data point is above or below the corresponding expected volume; (ii) if eight consecutive data points are each above the corresponding expected volume or below the corresponding expected volume; (iii) if six consecutive data points are trending upwards (i.e., form an upward slope) or trending downwards (e.g., form a downward slope); and (iii) if each of two or three consecutive data points is near (e.g., within a threshold difference) from the corresponding expected volume. For example, consider a scenario where the last eight data points for a Product Y are the last eight data points in the table 206t illustrated in FIG. 2C—i.e., Mar. 1, 2024 (12 incidents, expected volume 14), Mar. 4, 2024 (31 incidents, expected volume 21), Mar. 5, 2024 (29 incidents, expected volume 18), Mar. 6, 2024 (31 incidents, expected volume 20), Mar. 7, 2024 (28 incidents, expected volume 17), Mar. 8, 2024 (23 incidents, expected volume 15), Mar. 11, 2024 (23 incidents, expected volume 22), and Mar. 12, 2024 (20 incidents, expected volume 18). Continuing the example, the incident data analyzer 104i may detect one or more of following statistical exceptions: the last data point (March 12, 2024, with 20 incidents) is above the expected volume of 18 incidents for that date; all eight data points are above their corresponding expected volumes; six consecutive data points (29, 31, 28, 23, 23, and 20) show an increasing trend; and two or three consecutive data points, such as 23 and 20, are each near the corresponding expected volume (22 and 18, respectively) within a predefined threshold difference (e.g., 23 is within 2 from 22, and 20 is within 2 from 18).

Referring again to FIG. 2A, at 208, the incident data analyzer 104i may determine if statistical exception(s) have been detected. If the incident data analyzer 104i determines that statistical exception(s) have been detected (YES), then the incident data analyzer 104i may, at 210, generate first data.

As one example, the incident data analyzer 104i may create one or more tables of data for one or more (e.g., each) of the entities. The incident data analyzer 104i may populate the table with various information, including the entity (e.g., Product Y), the date (e.g., created date, such as incident report date), the number of incidents reported (e.g., created volume), the calculated expected volume for each date, the total number of incidents reported over the last eight dates, the sum of the expected volumes for the last eight dates, percentage difference (increase or decrease) between the total number of incidents reported over the last eight dates and the sum of the expected volumes for the last eight dates. For instance, the incident data analyzer 104i may create one or more tables similar to the table 206t illustrated in FIG. 2C.

As another example, the incident data analyzer 104i may create one or more charts of data for one or more (e.g., each) of the entities. The incident data analyzer 104i may plot various information in the charts, such as data that spans a select period (e.g., the last ninety weekdays). The data may include the total number of incidents for each date in the select period, the calculated expected volume for that date, and upper and/or lower thresholds (e.g., those calculated at step 204). For instance, the incident data analyzer 104i may create one or more charts similar to the chart 208c illustrated in FIG. 2D.

As yet another example, the incident data analyzer 104i may create a word cloud based on text descriptions of the incidents. The incident data analyzer 104i may create the word cloud by analyzing one or more fields in the incident data 204i that contain user-inputted words that describe encountered issues. The incident data analyzer 104i may analyze the text descriptions for (e.g., all) entities for which statistical exception(s) are detected for the most frequently occurring words and phrases, and may create the word cloud to visually represent these words and phrases, with the size of each word or phrase corresponding to its frequency of occurrence. For instance, the incident data analyzer 104i may create a word cloud similar to the word cloud 208w illustrated in FIG. 2E. In one or more embodiments, generative AI may be utilized to summarize the text descriptions of the incidents, which can complement the word cloud output with a natural language summary of the impact of the incidents on users. A generative AI model can analyze the text descriptions in the incident data 204i to identify key themes and insights. By leveraging techniques such as transformer-based models, the AI can generate concise summaries that highlight the most significant issues and their effects on users. For example, if multiple incidents report “email application not launching,” the generative AI might summarize this as “Frequent issues with email application startup affecting user productivity,” which can provide a clear and actionable overview of the incident trends and thus enhance the understanding of the incidents'impact on the affected users.

As a further example, the incident data analyzer 104i may present data for one or more (e.g., each) of the entities via the UI 104u of the incident data analysis and classification and resolution system 104. Referring to FIGS. 2F and 2G, example portions 208u and 208v of the UI 104u are respectively illustrated. The portions 208u and 208v may present various data, such as trend alerts relating to identified statistical exceptions (209t of the portion 208u), historical charts that identify average or control (e.g., expected volume) values for one or more (e.g., all) entities (209h of the portion 208v), and/or other relevant information. In various embodiments, the UI 104u may be user interactive, allowing users to select (e.g., via point and click or touch inputs) to view various layers of information, such as raw data extracts associated with entities for which trends have been detected (e.g., tables or charts for each such entity, such as those similar to the table 206t of FIG. 2C or the chart 208c of FIG. 2D).

As yet a further example, the incident data analyzer 104i may generate and provide a (e.g., daily) summary of data for one or more (e.g., each) of the entities. In various embodiments, the summary may be provided to one or more stakeholders (e.g., data analysts, department heads, etc.) in the form of a communication, such as an e-mail, a text message, or the like. For instance, the incident data analyzer 104i may generate the summary in a communication similar to the communication 208e illustrated in FIG. 2H. In one or more embodiments, the incident data analyzer 104i may include the summary in a hypertext markup language (HTML) table that is embedded in the body of the communication. The HTML table may display various information described above with respect to FIG. 2A, including, for instance, the entity (e.g., Product Y), whether there is an alert and its type (e.g., trend up, trend down, etc.), the sum of the created volume over the last eight weekdays, the sum of the expected volume over the last eight weekdays, the percentage difference as an increase or decrease, etc. In various embodiments, the incident data analyzer 104i may additionally, or alternatively, attach files to the communication to enable more detailed analysis. These attachments may include, for instance, one or more spreadsheets, documents, or images with some or all of the information described above with respect to FIG. 2A, such as tables/charts (e.g., those similar to the table 206t of FIG. 2C or the chart 208c of FIG. 2D), extracts of raw data, and/or a word cloud (e.g., similar to the word cloud illustrated in FIG. 2E). In a case where the HTML table is unable to be displayed in the body of the communication, the incident data analyzer 104i may attach the summary as a separate HTML file.

Referring again to FIG. 2A, after the incident data analyzer 104i generates the first data, the process 200 may end at 228. If, at 208, the incident data analyzer 104i determines, on the other hand, that statistical exception(s) have not been detected (NO), then the incident data analyzer 104i may generate second data. The second data may be similar to the first data, but may exclude the word cloud and/or may exclude trend-related data, since the incident activity for all entities is within expectations. After the incident data analyzer 104i generates the second data, the process 200 may end at 228.

At 214, the incident data analyzer 104i may extract raw data. For example, the incident data analyzer 104i may extract raw data relating to one or more (e.g., each) of the entities for which statistical exception(s) were detected (e.g., in step 206). The raw data may be extracted from the incident data 204i, and may include various details that provide context and information about the incidents that were reported for the entities. For instance, the raw data may include the specific entity (e.g., the name of the spreadsheet application, the name of the email application, etc.) for which the incidents were reported over a specified period (e.g., the last eight weekdays), the total number of incidents that were reported for the entity over the specified period, detailed information about each incident (e.g., text, audio, or other data provided by the reporting user that describes the incident), and/or information regarding the resolution of each incident (e.g., text, audio, or other data provided by a help desk representative regarding the solution(s) for resolving the incident). As an example, the raw data for the spreadsheet application may include incident information, such as crash reports, user complaints about slow performance, issues with data corruption, etc. The incident information may include user-provided descriptions of the problems, such as “The application crashes when I try to save a file” or “The application is very slow when I open large spreadsheet files.” The resolution information may include help desk responses, such as “Reinstalled the application to fix the crash issue” or “Cleared the application's cache to improve performance.” The resolution information may include detailed steps for resolving the incident, such as “Go to Settings>Cache>Clear Cache” and/or links to resources (e.g., web pages, videos, etc.) that explain how to resolve the incident, such as “Visit this link for a step-by-step video tutorial on clearing the cache.”

At 216, the incident data analyzer 104i may prepare data for AI model training. This preparation may involve various steps, such as label creation, label validation, data processing, quality checks, data formatting and cleanup, and/or feature engineering. The incident data analyzer 104i may create labels for the raw data to categorize and classify the incidents. For instance, incidents may be labeled based on their type (e.g., crash, performance issue, data corruption, etc.) or severity (e.g., critical, high, medium, low). Label creation is needed for supervised learning tasks, where the AI model learns to predict labels based on input data. For example, if the raw data includes incidents such as “The application crashes when I try to save a file” and “The application is very slow when I open large files,” the incident data analyzer 104i may label these incidents as “crash” and “performance issue,” respectively. The incident data analyzer 104i may validate created labels to ensure accuracy and consistency. This may involve cross-referencing the labels with historical data or using machine learning algorithms to verify the correctness of the labels. For instance, the incident data analyzer 104i may use natural language processing (NLP) techniques to analyze the text descriptions of the incidents and automatically generate labels based on the content. The incident data analyzer 104i may then validate these labels by comparing them with previously labeled data or by using a validation set of manually labeled incidents. The incident data analyzer 104i may perform quality checks to identify and correct any errors or inconsistencies in the raw data. For example, the incident data analyzer 104i may check for missing values, duplicate entries, or outliers that might skew the AI model's performance. Data formatting and cleanup involves converting raw data into a consistent or structured format that the AI model is capable of processing. This may include standardizing date formats, normalizing text data, and/or encoding categorical variables. Feature engineering is the process of selecting and transforming raw data into meaningful features that the AI model can use to make predictions. The incident data analyzer 104i may create new features based on the existing data, such as calculating the time between incidents, the frequency of specific types of incidents, or the average resolution time for each entity. For example, if the raw data includes timestamps for each incident, the incident data analyzer 104i may create a feature that represents the time of day when incidents are most likely to occur.

At 218, the incident data analyzer 104i may cause an AI model 104M to be trained using the prepared data. In various embodiments, the incident data analyzer 104i may select a portion of the prepared training data (e.g., 20% of the prepared training data) as reserved data for model testing purposes. This reserved data, which may also be referred to as a validation set, may be used to evaluate the performance of the AI model 104M after training. This allows for testing of the AI model 104M using data that the AI model 104M has not previously encountered, which can ensure that the AI model 104M is not overfitting to the training data.

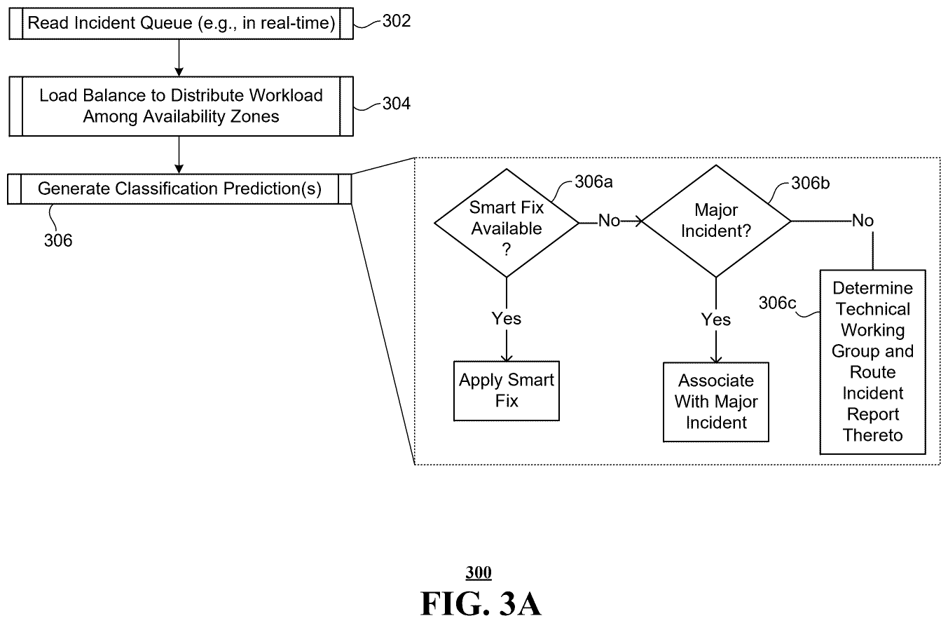

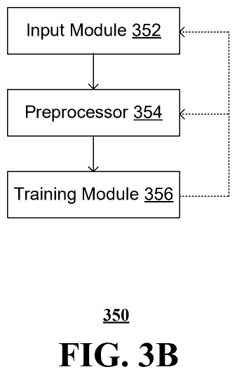

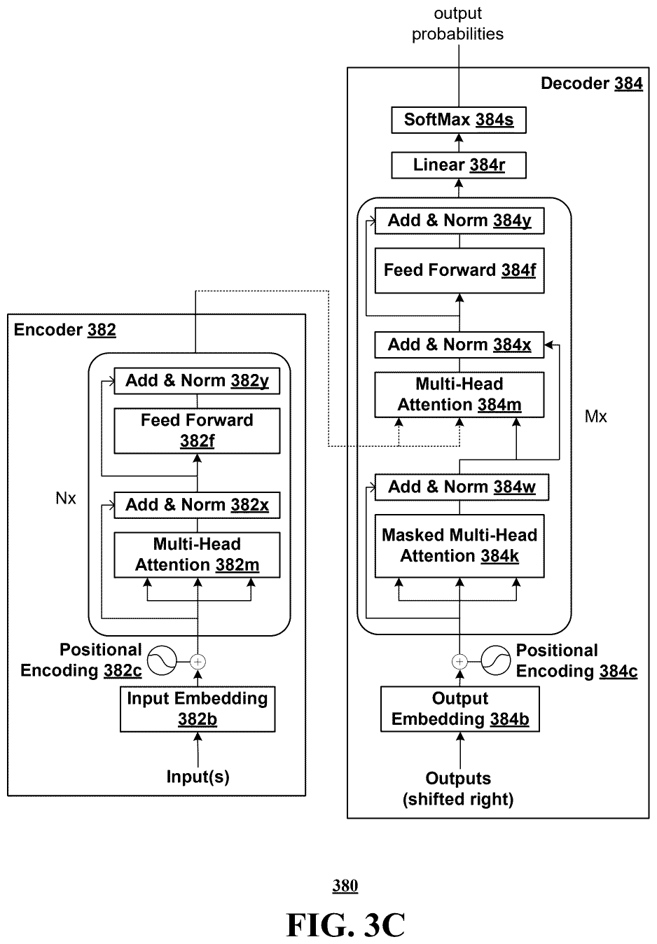

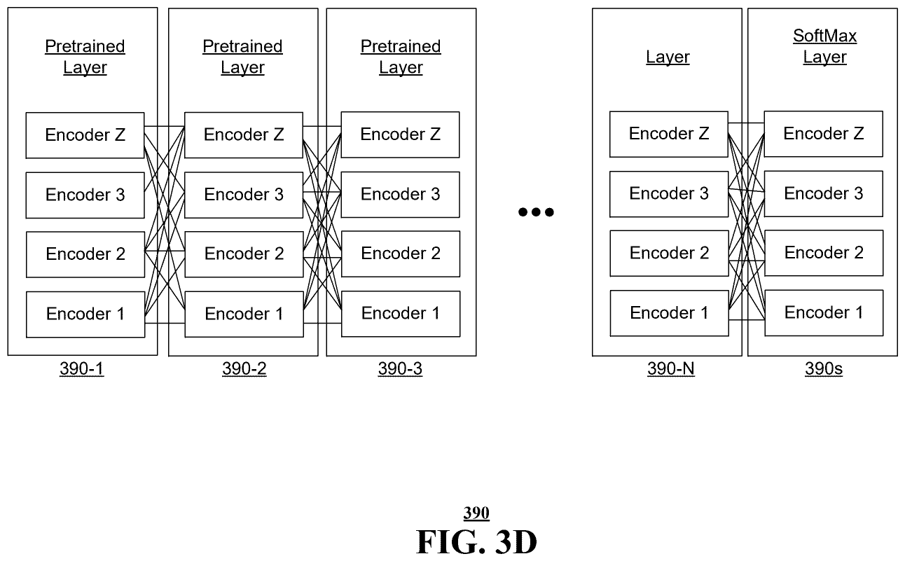

In one or more embodiments, the AI model 104M may be trained via an AI architecture (e.g., an AI architecture 350 illustrated in FIG. 3B and described in more detail below). The AI model 104M may include an LLM, such as an LLM that is based on the transformer model 380 illustrated in FIG. 3C and described in more detail below. In exemplary embodiments, the AI model 104M may include a BERT-based model, such as the BERT-based model 390 illustrated in FIG. 3D and described in more detail below.

The AI model 104M may be trained to classify incidents. In one or more embodiments, the AI model 104M may be trained to classify an incident as being resolvable using a known resolution, referred to herein as a “smart fix.” A smart fix may be an automated script that can be deployed to a user's device 106 to perform one or more actions when the script is executed by the user's device 106. In a case where the AI model 104M determines that a given incident corresponds to or matches a smart fix, the AI model 104M may output a recommendation to utilize that smart fix to resolve the incident.

In one or more embodiments, the AI model 104M may be trained to classify an incident as being associated with a known widespread issue that affects multiple users or systems, referred to herein as a “major incident.” In a case where the AI model 104M determines that a given incident corresponds to or matches a major incident, the AI model 104M may output a recommendation to associate the given incident with the major incident.

In one or more embodiments, the AI model 104M may be trained to classify an incident for routing to a technical working group. The technical working group may be a team or department that is responsible for handling specific types of incidents. For example, the AI model 104M may be trained to recommend that an incident be routed to a network support team if the incident is related to network connectivity issues. In some embodiments, the AI model 104M may be trained to classify an incident for such routing if the AI model 104M determines that no smart fix is available for the incident and that the incident does not correspond to any major incident.

Particular operations that the AI model 104M may perform to classify incidents are described in more detail below with respect to FIG. 3A.

The incident data analyzer 104i may select one or more algorithms for training the AI model 104M. For instance, the incident data analyzer 104i may use supervised learning techniques to train the model on the labeled data. Supervised learning involves providing the model with input-output pairs, where the input may be incident-related data and the output may be the corresponding label. The incident data analyzer 104i may perform hyper-parameter tuning to optimize the learning process. Hyper-parameters are settings that control the learning process, such as the learning rate, batch size, and the number of layers in the model. The incident data analyzer 104i may use techniques, such as grid search or random search, to find the optimal hyper-parameters that maximize the AI model 104M's performance. For example, the incident data analyzer 104i may experiment with different learning rates to determine which one leads to the fastest convergence and the best accuracy.

In various embodiments, the AI model 104M may be configured according to a sentence-transformers framework that maps sentences or paragraphs to a multi-dimensional dense vector space that can be used to facilitate semantic searches. In semantic search, entries in a corpus, such as sentences, paragraphs, or documents, are embedded in a vector space. The AI model 104M may be fine-tuned to generate embeddings that capture the semantic meaning of entire sentences, rather than mere individual tokens or words. This allows the AI model 104M to process an entire sentence as a single unit, and create a vector representation that encapsulates the overall meaning and context of the sentence. The AI model 104M may be fine-tuned using some or all of the prepared training data or other data derived from the prepared training data to produce high-quality sentence embeddings. The AI model 104M may be fine-tuned to generate embeddings that capture the semantic meaning of sentences, making them suitable for various downstream tasks that require an understanding of sentence-level context. This allows the AI model 104M to search the vector space in real-time when incidents are submitted to the AI model 104M for analysis and classification and resolution recommendation. At search time, for instance, the query (e.g., the user's report of the incident, such as “My e-mail isn't working”) may be embedded into the vector space, and the closest embeddings from the vector space may be found. In various embodiments, one vector database may be created for each entity (e.g., each software application, each diagnostic code, etc.) to reduce the search space and improve the AI model 104M's prediction or recommendation accuracy.

At 220, the incident data analyzer 104i may test the trained AI model 104M. For example, the incident data analyzer 104i may test the performance of the model using reserved data (e.g., 20% of the prepared training data described above with respect to step 218). In this way, the incident data analyzer 104i may input a set of incidents that were not part of the training data and compare the AI model 104M's recommended classifications/resolutions with actual or desired classifications/resolutions.

At 222, the incident data analyzer 104i may determine if prediction level(s) are satisfied. For example, the incident data analyzer 104i may evaluate the AI model 104M's accuracy, precision, recall, and/or other performance metrics. Accuracy measures the proportion of correct predictions that are made by the AI model 104M, while precision measures the proportion of true positive predictions out of all positive predictions. Recall measures the proportion of true positive predictions out of all actual positives. The incident data analyzer 104i may also evaluate metrics, such as F1 score (harmonic mean of precision and recall), area under the receiver operating characteristic curve (AUC-ROC), which measures the AI model 104M's ability to distinguish between classes. If the incident data analyzer 104i determines, at 222, that the prediction level(s) have not been satisfied (NO), then the process may end at 228. In various embodiments, the incident data analyzer 104i may also discard the AI model 104M and/or generate a user alert regarding the AI model 104's performance. For example, if the AI model 104M's accuracy is below a predefined threshold (e.g., 80%), then the incident data analyzer 104i may discard the AI model 104M and/or notify a development team to retrain the AI model 104M with additional data. If the incident data analyzer 104i determines, at 222, that the prediction level(s) have been satisfied (YES), then the process 200 may proceed to step 224.

At 224, the incident data analyzer 104i may cause the trained model to be uploaded to a model database. For example, the incident data analyzer 104i may cause the trained model to be uploaded to the AI models database 104d as an AI model 104M for use with real-time incident classification and resolution.

At 226, the incident data analyzer 104i may monitor the performance of the AI model 104M. For example, one or more instances of the AI model 104M—e.g., AI model instance 104m-1, 104m-2, etc.—may be deployed and run in the corresponding environment(s) 104e. The incident data analyzer 104i may monitor one or more key performance indicators (KPIs) relating to performance of the AI model instance(s) 104m, such as accuracy, response time, and/or user satisfaction. In various embodiments, the incident data analyzer 104i may continue monitoring such performance until one or more conditions have been satisfied, such as, for instance, a time-based threshold having been reached or a performance degradation having been detected. Continuous monitoring allows the incident data analyzer 104i to determine whether to initiate re-training of the AI model 104M as needed to maintain (e.g., optimal or desired) performance. For example, if the accuracy of one or more of the AI model instances 104m drops below a certain threshold, the incident data analyzer 104i may cause the AI model 104M to be re-trained using updated data, such as new incident reports, additional labeled data, or data that reflects recent changes in system or user behavior.

Process 200 may be performed periodically, such as each day, each week, etc., to generate updated first data or second data and/or to re-train the AI model 104M.

Referring to FIG. 3A, a process 300 is illustrated. The process 300 may be performed by the incident classifier/resolver 104r described above with respect to FIG. 1—e.g., by using one or more components of the incident classifier/resolver 104r, such as the controller/load balancer 104b, the prediction service(s) 104s, etc.

At 302, the incident classifier/resolver 104r may read an incident queue for incident reports. For example, the controller/load balancer 104b may read the incident queue 104q (e.g., in real-time or near real-time). Users may report incidents using the user device(s) 106, which may be stored as respective incident reports in the incident queue 104q. An incident report may be submitted in any format, such as text, audio, video, etc., and may provide a description of the incident. The description may include details regarding the incident, such as the entity (e.g., software application or service) that the user is experiencing a problem with, the nature of the problem (e.g., error messages or symptoms), the timing of the issue (e.g., when it occurs or how frequently), and/or any other relevant details (e.g., recent changes or actions taken by the user). For instance, a text description may include a specific error message, such as “e-mail application not launching” or “spreadsheet application crashes on save.” An audio description may include audio data in which a user verbally explains the issue, such as “The mobile app freezes when I try to log in.” A video description may include video data in which a user illustrates steps taken that lead to a problem, such as a screen recording of a database management application failing to load data. Such descriptions can aid in identifying the nature of the incident and provide context for further analysis and resolution.

At 304, the incident classifier/resolver 104r may load balance the read incident reports to distribute the workload among availability zones. For instance, the controller/load balancer 104b may load balance the read incident reports to distribute the classification and resolution workload among environments 104e. As an example, the controller/load balancer 104b may send a first incident report to the gateway 104g-1, a second incident report to the gateway 104g-2, and so on, where the gateway 104g-1 may forward the first incident report to the prediction service 104s-1 for handling by the AI model instance 104m-1, the gateway 104g-2 may forward the second incident report to the prediction service 104s-2 for handling by the AI model instance 104m-2, etc.

At 306, the incident classifier/resolver 104r may generate classification prediction(s). For instance, for a given incident report that is received by a prediction service 104s, the prediction service 104s may process the incident report using a corresponding AI model instance 104m. As part of step 306, the incident classifier/resolver 104r may, at 306a, determine whether a smart fix is available. For instance, continuing the aforementioned example, the prediction service 104s may determine whether at least one smart fix that matches the description of the incident is available. Assume, for example, that the incident report includes freeform text that is submitted by a user in an incident description dialog box or the like. In such a scenario, the AI model instance 104m may convert the text into semantic vectors (e.g., using a BERT-based model, such as the BERT-based model 390 illustrated in FIG. 3D). Such conversion may involve tokenizing of the text into individual words or phrases, and mapping the tokens to a high-dimensional vector space. For instance, the phrase “email application not launching” may be tokenized, where each token may be transformed into a vector that captures the meaning and context of the token within the sentence. The vectors may then be combined to form a semantic representation of the entire incident description.

The AI model instance 104m may compare the semantic vectors of the incident description against a database of vectors that represent smart fixes, such as pre-made scripts that can be executed by a device (e.g., the reporting user's user device 106) to resolve the incident. In various embodiments, the database of vectors that represent smart fixes may be made available for the AI model instance 104m to access to perform the comparison. The database of vectors may include references or links to resource locations (e.g., memory or storage) at which the pre-made scripts are stored and accessible for retrieval and transmission to user devices 106. In any case, the vector comparison may be based on cosine similarity or another distance metric for determining how closely the vectors match. If the similarity score between the incident description vector and a smart fix vector exceeds a specific certainty threshold, the AI model instance 104m may identify the corresponding smart fix as a potential solution. Use of this threshold may ensure that the identified smart fix is highly relevant to the reported incident.

If, at 306a, the incident classifier/resolver 104r determines that a smart fix is available (YES), the incident classifier/resolver 104r may output a command to cause the smart fix to be applied. For instance, further continuing the aforementioned example, if the incident classifier/resolver 104r determines that there is at least one smart fix that is highly relevant to the reported incident, the prediction service 104s may output a command to apply the smart fix whose corresponding smart fix vector has the highest similarity score. The output command may cause that smart fix (e.g., script) to be retrieved from a corresponding resource location and transmitted to the user device 106 for automatic execution by the user device 106 to resolve the incident.

If, at 306a, the incident classifier/resolver 104r determines that no smart fix is available (NO), the incident classifier/resolver 104r may, at 306b, determine whether the incident is related to a major incident. For instance, further continuing the aforementioned example, the prediction service 104s may determine whether the incident is related to a major incident. Assume again, for example, that the incident report includes freeform text that is submitted by a user in an incident description dialog box or the like, and where the AI model instance 104m converts the text into semantic vectors. The AI model instance 104m may compare the semantic vectors of the incident description against a database of vectors that represent major incidents. In various embodiments, the database of vectors that represent major incidents may be made available for the AI model instance 104m to access to perform the comparison. The database of vectors may include information, such as text-based descriptions, relating to the major incidents (e.g., major firmwide e-mail outage). In any case, the vector comparison may be based on cosine similarity or another distance metric for determining how closely the vectors match. If the similarity score between the incident description vector and a major incident vector exceeds a specific certainty threshold, the AI model instance 104m may identify the corresponding major incident as a potential match to the reported incident. Use of this threshold may ensure that the identified major incident is highly relevant to the reported incident.

If, at 306b, the incident classifier/resolver 104r determines that the incident is related to a major incident (YES), the incident classifier/resolver 104r may output a command to associate the incident with the major incident. For instance, further continuing the aforementioned example, if the prediction service 104s determines that there is at least one major incident that is highly relevant to the reported incident, the prediction service 104s may output a command to associate the reported incident with the major incident whose corresponding major incident vector has the highest similarity score. The output command may cause the reported incident to be associated with (e.g., marked as being part of) the major incident. In this way, reported incidents that are all associated with the major incident can all be easily cleared or marked as resolved once the major incident itself is resolved.

If, at 306b, the incident classifier/resolver 104r determines that the incident is not related to a major incident (NO), the incident classifier/resolver 104r may determine a technical working group to route the reported incident to. For instance, further continuing the aforementioned example, the prediction service 104s may determine a technical working group to route the reported incident to. Assume again, for example, that the incident report includes freeform text that is submitted by a user in an incident description dialog box or the like, and where the AI model instance 104m converts the text into semantic vectors. The AI model instance 104m may compare the semantic vectors of the incident description against a database of vectors that represent technical working groups. In various embodiments, the database of vectors that represent technical working groups may be made available for the AI model instance 104m to access to perform the comparison. The database of vectors may include information, such as text-based descriptions, relating to the technical working groups (e.g., network team, employ rewards department, etc.). The database of vectors may also include communication references or links (e.g., e-mail addresses, phone numbers, etc.) via which the technical working groups may be reached. In any case, the vector comparison may be based on cosine similarity or another distance metric for determining how closely the vectors match. If the similarity score between the incident description vector and a technical working group vector exceeds a specific certainty threshold, the AI model instance 104m may identify the corresponding technical working group as a potential match to the reported incident. Use of this threshold may ensure that the identified technical working group is highly relevant to the reported incident.

The incident classifier/resolver 104r may output a command to route the reported incident to an identified technical working group. For instance, further continuing the aforementioned example, the prediction service 104s may output a command to route the reported incident to an identified technical working group. The output command may cause information regarding the reported incident to be transmitted to the technical working group, such as via a communication reference or link that corresponds to that technical working group.

It is to be understood and appreciated that, although one or more of FIGS. 1, 2A, and 3A might be described above as pertaining to various processes and/or actions that are performed in a particular order, some of these processes and/or actions may occur in different orders and/or concurrently with other processes and/or actions from what is depicted and described above. Moreover, not all of these processes and/or actions may be required to implement the systems and/or methods described herein. Furthermore, while various components, devices, systems, modules, etc. may have been illustrated in FIG. 1 as separate components, devices, systems, modules, etc., it will be appreciated that multiple components, devices, systems, modules, etc. may be implemented as a single component, device, system, module, etc., or a single component, device, system, module, etc. may be implemented as multiple components, devices, systems, modules, etc. Additionally, functions described as being performed by one component, device, system, module, etc. may be performed by multiple components, devices, systems, modules, etc., or functions described as being performed by multiple components, devices, systems, modules, etc. may be performed by a single component, device, system, module, etc.

Referring to FIG. 3B, the AI architecture 350 may be used to facilitate training and/or pre-training of AI models, such as AI model(s) 104M of the incident classifier/resolver 104r described above with respect to FIGS. 1 and 3A.

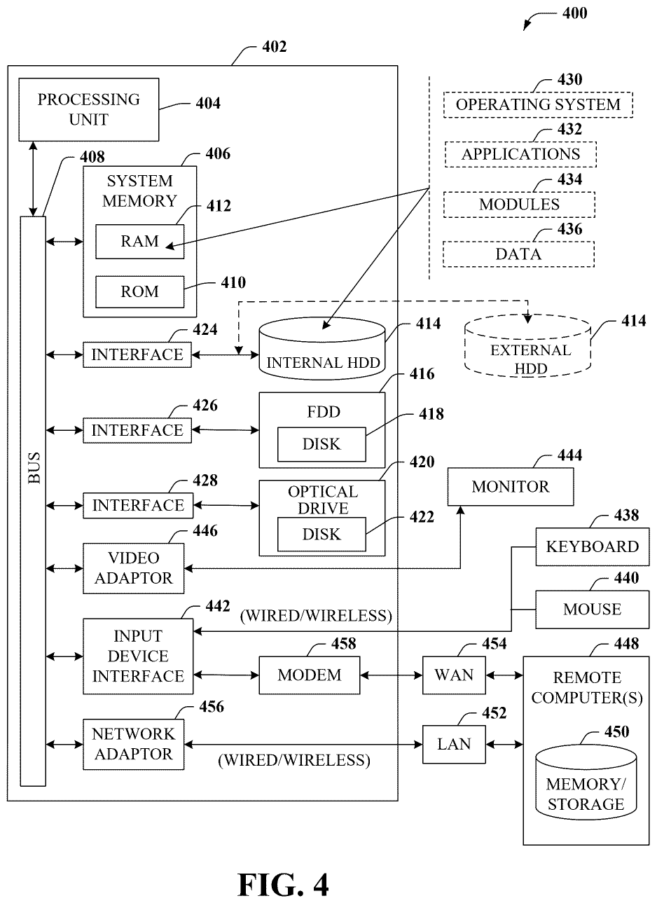

The AI architecture 350 may include an input module 352, a preprocessor 354, and a training module 356. Some or all of these modules, which may be referred to as programs, processors, or agents, may be realized based on execution of instructions or data by one or more processors of a computing (or machine learning (ML)) system, such as the computing system 400 of FIG. 4 (described in more detail below).

The input module 352 may allow for input of (e.g., user-provided) data, such as datasets, parameters (e.g., weights, biases, and/or the like), etc., that can be used to train models and/or obtain predictions from models. In some cases, datasets may be labeled and may include inputs (e.g., observed or measured values) and known output data. Labeled datasets may facilitate supervised (or guided) learning.

Although not shown, the AI architecture 350 may include a library of ML models or algorithms, such as, for instance, one or more classifiers (e.g., a naïve Bayes classifier or the like), one or more support vector machines, one or more artificial neural networks (e.g., transformer neural networks, convolutional neural networks, and/or the like), one or more learned decision trees, and so on. Each of the ML algorithms may be associated with various parameters.

The preprocessor 354 may be equipped with one or more preprocessing algorithms that are configured to prepare input datasets for processing by the training module 356. Such preprocessing may include discretization (where values are binned or converted into nominal values), component analysis, data estimation, feature selection, feature extraction (e.g., dimensionality reduction, data removal, statistical analysis, threshold-based filtering, etc.), data interpolation, and/or the like.

The training module 356 may be configured to train and evaluate ML models. As an example, the training module 356 may be configured to perform unsupervised learning and/or supervised learning based in input datasets. In exemplary embodiments, the training module 356 may be capable of training and/or evaluating the performance of multiple models in parallel. In one or more implementations, the training module 356 may, despite operating on multiple ML models in parallel, train and evaluate the various ML models individually. In some implementations, the training module 356 may be capable of combining the procedure outcomes of multiple models to derive an aggregate outcome. Model evaluation or validation may involve a comparison of model outputs to known outputs or an analysis of model outputs relative to desired metrics.

In exemplary embodiments, certain processing techniques may be employed to generate usable data sets for feeding into the AI architecture 350 to train deep learning neural network model(s) to output predictions. Although not illustrated, the AI architecture 350 may include additional functional modules, such as those for gathering performance results and presenting (e.g., displaying) data regarding the results. While various components, modules, etc. may have been illustrated in FIG. 3B as separate components, modules, etc., it will be appreciated that multiple components, modules, etc. can be implemented as a single component, module, etc., or a single component, module, etc. can be implemented as multiple components, modules, etc. Additionally, functions described as being performed by one component, module, etc. may be performed by multiple components, modules, etc., or functions described as being performed by multiple components, modules, etc. may be performed by a single component, module, etc.

Referring to FIG. 3C, an example transformer model 380 (a portion or an entirety of which can serve as a functional building block of one or more LLMs (e.g., LLM(s) used in the incident classifier/resolver 104r described above with respect to FIGS. 1 and 3A)) may include an encoder 382 and a decoder 384. The encoder 382 may include an input embedding block 382b, a positional encoder 382c, and a series of (i.e., multiple (Nx)) identical layers that each has a multi-head attention block 382m and a feed forward block 382f. An input (e.g., text, such as a query or a prompt) may be converted into individual tokens (e.g., words, characters, etc.) that are fed into the input embedding block 382b. The input embedding block 382b may convert the tokens into continuous vectors, where each token is mapped to a high-dimensional space by way of a learned embedding matrix. The embedding matrix may be implemented in a lookup table or the like, where token indexes are associated with different vectors of a fixed size. The positional encoder 382c may derive fixed positional encodings or learned positional encodings to help capture positional information of tokens. Fixed positioning encodings may be generated using sinusoidal functions, where the different frequencies of sine/cosine functions correspond to unique positional encodings for the different positions in a given sequence. Learned positional encodings may be learned during training based on initially randomly chosen values that are optimized as part of the training process. In any case, the positional encodings may be combined with the input embeddings from the input embedding block 382b on an element-by-element basis, resulting in a processed input that may be fed into the series of layers. The processed input may be fed into the multi-head attention block 382m in the first layer. An addition (or residual connection) and normalization block 382x may operate on the processed input and the output of that multi-head attention block 382m. The output of the addition and normalization block 382x may be passed to the feed forward block 382f in that layer. An addition and normalization block 382y may operate on the output of the addition and normalization block 382x and the output of the feed forward block 382f. In essence, the multi-head attention block 382m of a given layer may enable the feed forward block 382f in that layer to model long term dependencies. Multi-head attention allows the model to simultaneously attend to different parts of the input sequence and weigh their importance based on the input sequence's internal relationships. This attention mechanism may be combined with the input sequence's representations to produce a new set of weighted representations. Iterating the identical layers allows the model to learn complex patterns and relationships in the data.

The decoder 384 may include an output embedding block 384b, a positional encoder 384c, and a series of (i.e., multiple (Mx)) identical layers that each has a masked multi-head attention block 384k, a multi-head attention block 384m, and a feed forward block 384f. An output (shifted right) may be converted into individual tokens that are fed into the output embedding block 384b. The output embedding block 384b may convert the tokens into continuous vectors. The positional encoder 384c may derive fixed positional encodings or learned positional encodings to help capture positional information of tokens. The processed output may be fed into the masked multi-head attention block 384k in the first layer. An addition and normalization block 384w may operate on the processed output and the output of that masked multi-head attention block 384k. The output of the addition and normalization block 384w may be passed to the multi-head attention block 384m in that layer. Output(s) from the encoder 382 may also be fed into the multi-head attention block 384m. An addition and normalization block 384x may operate on the output of the addition and normalization block 384w and the output of multi-head attention block 384m. The output of the addition and normalization block 384x may be passed to the a feed forward block 384f in that layer. An addition and normalization block 384y may operate on the output of the addition and normalization block 384x and the output of the feed forward block 384f. The output of the addition and normalization block 384y may may be passed to a linear layer 384r, which may transform that output into a higher-dimensional space. The output of the linear layer 384r may be fed into a SoftMax layer 384s, which may be a non-linear activation function that normalizes the output to a probability distribution to ensure that all values are non-negative and add up to 1. Iterating the identical layers allows the model to learn complex patterns and relationships in the data.

Various types of transformer-based LLMs may be constructed by “stacking” the identical layers of the encoder 382 and/or the decoder 384 in particular arrangements and in combination with additional refinements/components. A given LLM constructed as such may then be trained or pre-trained (e.g., using the AI architecture 350 of FIG. 3A, a similar AI architecture, a different AI architecture or a combination of some or all of these AI architectures) on a corpus of information and/or finetuned or instruction-tuned to analyze/generate data (e.g., text, audio, and/or images).

Referring to FIG. 3D, the BERT-based model 390 may include pretrained layers 390-1, 390-2, and 390-3. These layers may be pretrained on a large corpus of data (e.g., text, audio, etc.) in one or more languages. The BERT-based model 390 may also include a layer 390-N for fine-tuning purposes and a SoftMax layer 390s for transforming outputs of the layer 390-N into a probability distribution, similar to the SoftMax layer 384s described above with respect to the transformer model 380 of FIG. 3C. The fine-tuning in the layer 390-N may be based on training data, such as the prepared training data described above with respect to step 216 of FIG. 2A. Each of the pretrained layers 390-1, 390-2, and 390-3, the layer 390-N, and the SoftMax layer 390s may include encoders (1, 2, 3, . . . Z), which may be constructed with input embedding blocks, positional encoders, multi-head attention blocks, and feed-forward blocks, similar to those described above with respect to the transformer model 380 of FIG. 3C.

While examples of calculations relating to the incident data 204i have been described above with respect to FIG. 2A as corresponding to data for weekdays, the calculations may additionally or alternatively be performed on data for other days, such as weekends (i.e., Saturday and/or Sunday). In some embodiments, data for holidays may be excluded from the calculations, whereas, in other embodiments, data for some or all holidays may be included in the calculations.

While the incident classifier/resolver 104r has been described above with respect to FIGS. 1 and 3A as including/involving load balancing of workloads across multiple environments, load balancing may be optional. For instance, in certain embodiments, the incident classifier/resolver 104r may include or operate with only a single environment 104e. In these embodiments, the load balancing function of the controller/load balancer 104b may or may not be needed as incident reports may be processed within the single environment 104e.

In various embodiments, the process 200 of FIG. 2A and the process 300 of FIG. 3A may be run separately, but in parallel with one another. For example, the incident data analyzer 104i may (e.g., continuously) monitor and analyze incident data 204i for statistical exceptions as described above with respect to FIG. 2A, while the incident classifier/resolver 104r may (e.g., simultaneously) perform incident classification and resolution as described above with respect to FIG. 3A.

Referring to FIG. 4, a computing environment 400 is illustrated. In various embodiments, computing environment 400 may facilitate, in whole or in part, incident-related trend and statistical exception recognition and AI-based automated incident classification and resolution.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

Referring again to FIG. 4, the example environment 400 can include a computer 402, the computer 402 including a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 includes ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also include a high-speed RAM such as static RAM for caching data.

The computer 402 further includes an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations includes at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, including an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can include a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically includes other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically includes many or all of the elements described relative to the computer 402, although, for purposes of brevity, only a remote memory/storage device 450 is illustrated. The logical connections depicted include wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also include a wireless AP disposed thereon for communicating with the adapter 456.

When used in a WAN networking environment, the computer 402 can include a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

In various embodiments, threshold(s) may be utilized as part of determining/identifying one or more actions to be taken or engaged. The threshold(s) may be adaptive based on an occurrence of one or more events or satisfaction of one or more conditions (or, analogously, in an absence of an occurrence of one or more events or in an absence of satisfaction of one or more conditions).

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim. It is also to be understood and appreciated that the subject matter in one or more dependent claims may be combined with that in one or more other dependent claims.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data or unstructured data. Computer-readable storage media can include the widest variety of storage media including tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized. It is also to be understood and appreciated that the subject matter in one or more dependent claims may be combined with that in one or more other dependent claims.

What is claimed is:

1. A device, comprising:
a processing system including a processor; and
a memory that stores executable instructions that, when executed by the processing system, facilitate performance of operations, the operations comprising:
obtaining a description of an incident relating to an entity,
wherein the description is provided from a user device associated with a user, and
wherein the entity comprises a product or a service that is offered by an organization to a plurality of users that includes the user;
generating, using an artificial intelligence (AI) model, a recommended classification for the incident based on the obtaining, wherein the generating involves converting the description into a vector and performing semantic searching for the vector in one or more databases of vectors; and
based on the recommended classification, causing an automated pre-programmed script to be deployed the user device, wherein deployment of the automated pre-programmed script triggers the user device to execute the automated pre-programmed script to resolve the incident.

2. The device of claim 1, wherein the recommended classification comprises classification of the incident as being resolvable using the automated pre-programmed script.

3. The device of claim 1, wherein the operations further comprise:
obtaining another description of another incident relating to another entity;
generating, using the AI model, another recommended classification for the another incident; and
causing an action to be performed in relation to the another incident based on the another recommended classification.

4. The device of claim 3, wherein the another recommended classification comprises classification of the another incident as belonging to a known major incident.

5. The device of claim 4, wherein the action comprises associating the incident with the known major incident.

6. The device of claim 3, wherein the another recommended classification comprises classification of the another incident as corresponding to a technical working group.

7. The device of claim 6, wherein the action comprises routing data regarding the incident to the technical working group.

8. The device of claim 1, wherein the one or more databases of vectors comprise vectors relating to automated pre-programmed scripts for resolving incidents.

9. The device of claim 1, wherein the one or more databases of vectors comprise vectors relating to known major incidents.

10. The device of claim 1, wherein the one or more databases of vectors comprise vectors relating to technical working groups.

11. The device of claim 1, wherein the AI model comprises a first AI model instance of a plurality of AI model instances, and wherein the operations further comprise, according to load balancing across the plurality of AI model instances, providing the description to the first AI model instance to generate the recommended classification.

12. The device of claim 1, wherein the AI model is trained based on results of statistical exception analysis of incident data relating to a plurality of entities that includes the entity.

13. The device of claim 12, wherein the statistical exception analysis includes identifying trends or outlier data points in the incident data.

14. The device of claim 1, wherein the obtaining is responsive in real-time to a received report of the incident.

15. A non-transitory machine-readable medium, comprising executable instructions that, when executed by a processing system including a processor, facilitate performance of operations, the operations comprising:
training an artificial intelligence (AI) model using results of statistical exception analysis of incident data relating to a plurality of entities,
wherein the AI model is trained to generate recommended classifications of incidents associated with one or more of the plurality of entities,
wherein the training of the AI model involves fine tuning of a transformer-based pre-trained model that understands natural language,
wherein the fine tuning is based on text in the incident data, and
wherein the plurality of entities comprise products or services that are offered by an organization to a plurality of users; and
causing one or more instances of the AI model to be deployed into one or more service environments to facilitate automatic classification or resolution of reported incidents.

16. The non-transitory machine-readable medium of claim 15, wherein the automatic classification or resolution of reported incidents comprises semantic searching that involves conversions of descriptions associated with the reported incidents into vectors, and comparisons of the vectors with other vectors in one or more databases of vectors.

17. The non-transitory machine-readable medium of claim 15, wherein the recommended classifications comprise, for a reported incident, classification of the reported incident as being resolvable using an automated pre-programmed script, as belonging to a known major incident, or as corresponding to a technical working group.

18. A method, comprising:
receiving, by a processing system including a processor, a description of an incident relating to an entity,
wherein the description is provided from a user device associated with a user, and
wherein the entity comprises a product or a service that is offered by an organization to a plurality of users that includes the user;
responsive to the receiving, predicting, by the processing system and using an artificial intelligence (AI) model, a classification for the incident based on the description,
wherein the predicting comprises converting the description into a vector and performing semantic searching for the vector in one or more databases of vectors; and
based on the classification, causing, by the processing system, an automated pre-programmed script to be deployed the user device, wherein deployment of the automated pre-programmed script triggers the user device to execute the automated pre-programmed script to resolve the incident.

19. The method of claim 18, wherein the one or more databases of vectors comprise vectors relating to automated pre-programmed scripts for resolving incidents, vectors relating to known major incidents, and vectors relating to technical working groups.

20. The method of claim 19, wherein the predicting involves sequential semantic searching such that searching relative to the vectors relating to technical working groups is performed after a known major incident is unable to be identified from searching relative to the vectors relating to known major incidents, and the searching relative to the vectors relating to known major incidents is performed after an automated pre-programmed script is unable to be identified from searching relative to the vectors relating to automated pre-programmed scripts.
